(19) United States
(12) Patent Application Publication
(10) Pub. No.: US 2016/0172765 A1
(43) Pub. Date: Jun. 16, 2016

(54) OPTICALLY TRANSPARENT PANEL ANTENNA ASSEMBLY COMPRISING A SHAPED REFLECTOR

(71) Applicants: BOUYGUES TELECOM, Paris (FR); ALCATEL-LUCENT SHANGHAI BELL CO., LTD, Shanghai (CN)

(72) Inventors: Eduardo Motta-Cruz, Saint Herblain (FR); Pierre-Antoine Garcia, Rennes (FR); Jean-Pierre Harel, Lannion (FR); David Cornec, Hengoat (FR); Thomas Julien, Lannion (FR)

(73) Assignees: Bouygues Telecom, Paris (FR); Alcatel-Lucent Shanghai Bell Co., Ltd., Shanghai (CN)

(21) Appl. No.: 14/908,075

(22) PCT Filed: Jul. 29, 2014
(86) PCT No.: PCT/EP2014/066271

§ 371 Date: Jan. 27, 2016

(30) Foreign Application Priority Data
Jul. 29, 2013 (EP) 13306092.1

(51) Int. Cl. H01Q 15/14

(52) U.S. Cl. CPC H01Q 15/14

(57) ABSTRACT

The invention concerns an optically transparent panel antenna assembly comprising an optically transparent antenna having an array of radiating elements that transmit or receive RF signals, said assembly comprising a reflector optically transparent, said reflector comprising a lower wall, two lateral walls each lateral wall extending therefrom the lower wall so that the array of radiating elements is maintained between both lateral walls of the reflector.

### FIELD OF THE INVENTION

The invention relates to the field of panel antennas, particularly those used in cellular networks.

### BACKGROUND OF THE INVENTION

Base-station antennas ensure radio electric coverage in cellular telecommunications networks. Basically, base stations are made with directional panel antennas, especially those with 120° azimuth coverage. This coverage can be evaluated by measuring antenna's radiation pattern in the horizontal plane.

That way, three panel antennas are needed to ensure coverage within the full azimuth range (360°). This configuration yields a “trisector base-station”.

As known, in order to obtain the desired horizontal pattern, panel antennas include a U-shaped metallic reflector. This ensures high directivity while controlling the horizontal beam width. Such antennas are described for instance in documents WO 03/085782 A1 and US 2007/0001919 A1.

A problem is that these metallic reflectors have de facto an important weight so that the base-station antennas are subject to major constraint in terms of integration especially on building frontages.

There is a need for a reflector, ensuring control of radiation pattern whatever the antenna dimensions, with optimal use of metallic materials to reduce antenna weight and to facilitate the integration of the antennas in the building especially in glazed surfaces with dimensions greater than the antennas.

### SUMMARY OF THE INVENTION

The invention relates to an optically transparent panel antenna assembly comprising an optically transparent antenna having an array of radiating elements that transmit or receive RF signals, said assembly comprising a reflector optically transparent, said reflector comprising a lower wall, two lateral walls each lateral wall extending therefrom the lower wall so that the array of radiating elements is maintained between both lateral walls of the reflector.

The invention may also have one of the features here below:

it comprises a frame having two lateral walls, a bottom and a top walls, the lateral walls and the top and the bottom walls defining a housing for the optically transparent antenna;

the reflector comprises two diagonal lateral wings extending from each lateral wall of the reflector toward the lateral walls of the frame;

the reflector comprises two diagonal lateral wings extending from each lateral wall of the frame toward the bottom of the frame;

the reflector comprises two horizontal wings extending horizontally from the top of the lateral walls of the reflector towards the lateral walls of the frame, said horizontal wing being parallel to the lower wall of the reflector;

the reflector comprises two diagonal wings extending from the top of a lateral wall of the reflector, two horizontal wings extending horizontally from the diagonal wings, said horizontal wing being parallel to the lower wall of the reflector;

the reflector comprises two electrical chokes which are U-shaped, and connected to each horizontal wing, the electrical choke can comprise a bottom wall and two lateral walls, each lateral wall being parallel to the bottom wall of the reflector or parallel to the lateral wall of the reflector;

the reflector comprises at least one diagonal wing parallel to each lateral wall of the reflector for forming electrical chokes on either side of the lateral walls of the reflector;

reflector comprises two electrical chokes each comprising a bottom wall and two lateral walls, each electrical chokes being disposed so that the lateral walls of the electrical chokes are parallel to the lateral walls of the reflector;

each radiating element comprises a lower substrate; an upper substrate; and an intermediate substrate; being arranged between the lower wall of the reflector and the upper wall, the substrates being optically transparent and preferably made of glass;

it comprises a radiating assembly arranged between the lower substrate and the upper substrate; two transmission lines formed by metallic meshing on the surface of the lower substrate opposite the lower wall of the reflector and which extend respectively from two opposite edges of the lower-substrate towards the radiating assembly such that when the transmission lines are powered they cause radiation of the radiating assembly, through two slots and etched on the ground plane;

the reflector is constituted by a substrate which is optically transparent and a layer of a metallic meshing;

the metallic meshing is a metallic squared mesh in form of a grid;

the metallic meshing is made of transparent semiconductor materials such as Indium Thin Oxide.

The invention presents several advantages.

The use of a reflector which is optically transparent ensures easily the integration in the glazed surfaces

Also, it reduces metal usage while maintaining antenna optical transparency, with the use of optically transparent materials, and metallic foils with a special machining that makes them transparent.

Using optically transparent materials allows optically transparent designs, which is impossible when using classic metallic materials, because they are inherently opaque.

Also, for a given volume, using optically transparent materials allows reduced weight systems, with reduction rate near 50% when comparing to aluminum systems, widely used for their lightness, whose volumic weight is about 2700 kg/m3. The glass is a particular case, because its volume weight is equivalent to aluminum.

Using metallic foils instead of metallic chassis allows reduced metal usage, and eases the machining process that yields optically transparent conductive parts.

### BRIEF DESCRIPTION OF THE DRAWINGS

Other features and advantages of the invention will appear in the following description. Embodiments of the invention will be described with reference to the drawings, in which

FIG. 1 and FIG. 2 illustrate an optically transparent panel antenna assembly according to a first embodiment of the invention;

FIG. 3 illustrates a cross section of a reflector of the optically transparent panel antenna assembly according to the first embodiment of the invention;

FIGS. 4a and 4b illustrate an optically transparent panel antenna assembly according to a second embodiment of the invention;

FIGS. 5a and 5b illustrate an optically transparent panel antenna assembly according to a third embodiment of the invention;

FIGS. 6a and 6b illustrate an optically transparent panel antenna assembly according to a fourth embodiment of the invention;

FIGS. 7a and 7b illustrate an optically transparent panel antenna assembly according to a fifth embodiment of the invention;

FIGS. 8a and 8b illustrate an optically transparent panel antenna assembly according to a sixth embodiment of the invention;

FIGS. 9a and 9b illustrate an optically transparent panel antenna assembly according to a seventh embodiment of the invention;

FIG. 10 illustrates an optically transparent panel antenna assembly according to an eighth embodiment of the invention;

FIG. 11 illustrates an optically transparent panel antenna assembly according to a ninth embodiment of the invention;

FIGS. 12a and 12b illustrate an optically transparent panel antenna assembly according to a tenth embodiment of the invention;

FIGS. 13a and 13b illustrate an optically transparent panel antenna assembly according to an eleventh embodiment of the invention;

FIG. 14 illustrate a cross section of a radiating element of the optically transparent panel antenna assembly according to the invention;

FIG. 15 illustrates the principle of the meshing used for fabricating the optically transparent panel antenna assembly according to the invention. Throughout the figures, similar elements have identical numerals references.

### DETAILED DESCRIPTION OF THE INVENTION

By “optically transparent”, it is meant a material that is substantially transparent to visible light allowing at least 30% of this light to pass, and preferably more than 60% of the light.

General description

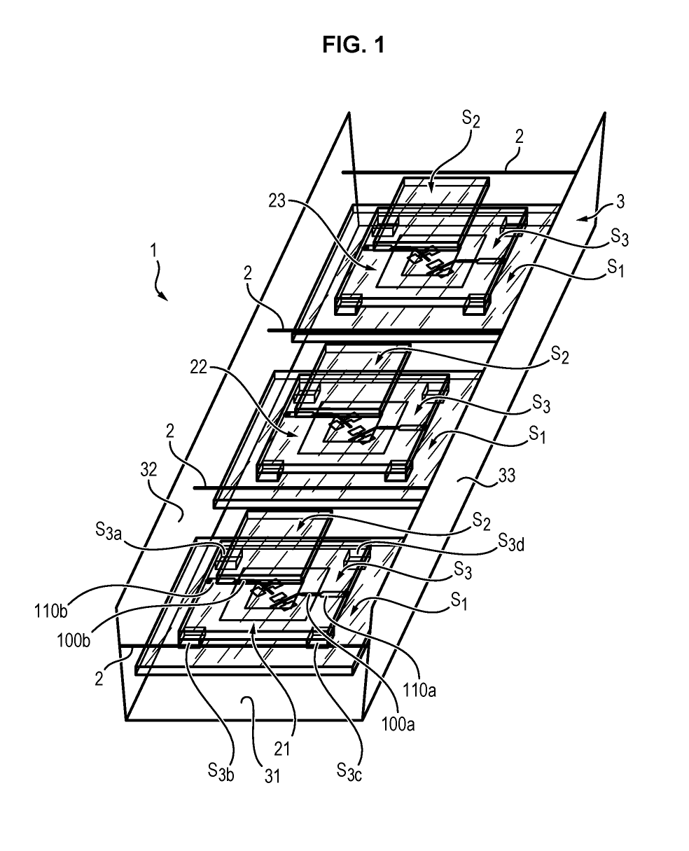

In relation to FIG. 1, an optically transparent panel antenna assembly according to a first embodiment of invention comprises an optically transparent antenna 1 having an array of radiating elements 21, 22, 23 that transmit or receive RF signals.

By “array of radiating elements” it is meant an assembly of radiating elements which are distinct from one another and fed in a synchronous manner.

In order to both controlling the radiation pattern and reducing the metal usage, the assembly comprises a reflector 3 which is optically transparent. The reflector 3 comprises a lower wall 31, two lateral walls 32, 33 each lateral wall extending therefrom the lower wall 21 so that the array of radiating elements 21, 22, 23 is maintained between both lateral walls 32, 33 of the reflector 3.

The reflector 3 serves as a ground plane for the optically transparent antenna 1 and in particular for each radiating element.

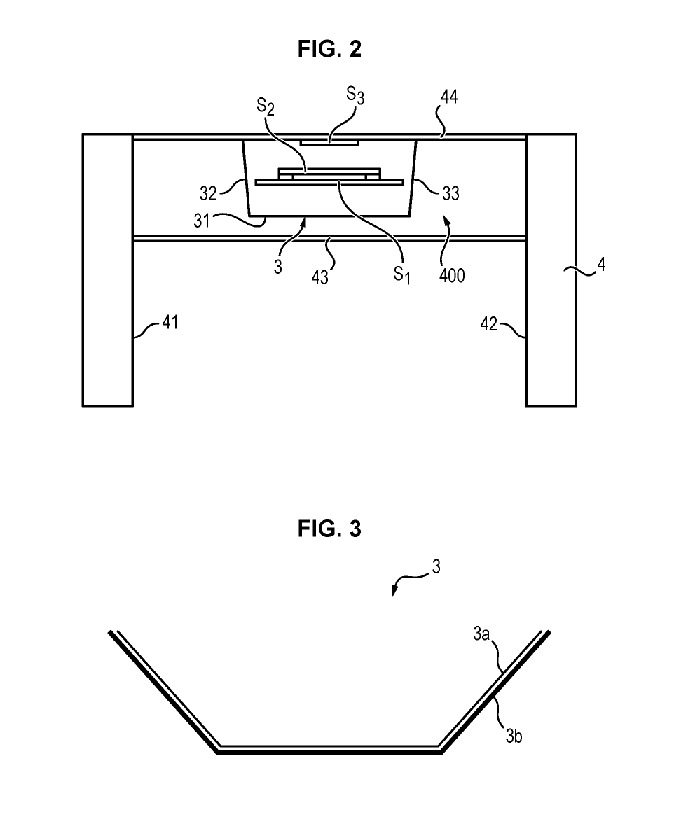

In order to integrate the assembly and for protecting the various elements constituting the optically transparent antenna 1, the assembly comprises (see FIG. 2) a frame 4 which has two lateral walls 41, 42, a bottom wall 43 and a top wall 44, the walls 41, 42, 43 of the frame define a housing 400 wherein the reflector is disposed.

The reflector is in the housing and is maintained in position in this latter by any means that the man skilled in the art may find appropriate.

The lateral walls 41, 42 of the frame are in a metallic, plastic, organic or mineral material. For the integration in glazed surfaces, the bottom wall 43 and the top wall 44 of the frame 4 can be made of glass or any other transparent material such as plastics, i.e., for example Glass, PMMA, PET and PETG for example.

The reflector 3 is optically transparent and is constituted (see FIG. 3) by a substrate 3a which is optically transparent and a layer 3b of a conductive metallic meshing, the mesh being a squared mesh and is optically transparent.

The substrate 3a is used as a mechanical support for the layer 3b and can be an electrically insulating material with a defined or measurable relative dielectric permittivity also called dielectric constant εr. The substrate 3a can be chosen in the following groups of materials: Glass, Polycarbonate, PMMA, PET and PETG and other dielectric materials

Advantageously, the conductive metallic meshing can be obtained from a metallic foil machined in such a way it becomes optically transparent while keeping an electrical opacity. This machining is called “meshing” and is described as follows.

Complementary, the optically transparent panel antenna assembly comprises (see FIG. 1) metallic wires 2 disposed regularly between the lateral walls of the reflector 3.

These metallic wires 2 allow optimizing radiating performances such as minimizing cross-polarization levels which leads to high polarization purity, as well as high isolation between ports if needed.

The reflector 3 is not limited to the one described in relation to FIGS. 1 to 3 but can take one of the following shapes in various embodiments of the invention.

Description of Various Shapes of the Reflector

By “diagonal lateral wing”, it is meant a wall that is not perpendicular to the lower wall of the reflector 3 and disposed on the side of a lateral wall of the reflector 3.

By “horizontal wing”, it is meant a wall that is parallel to the lower wall of the reflector 3.

For the sake of clarity, the radiating elements are not represented on the figures corresponding to the embodiments described here below.

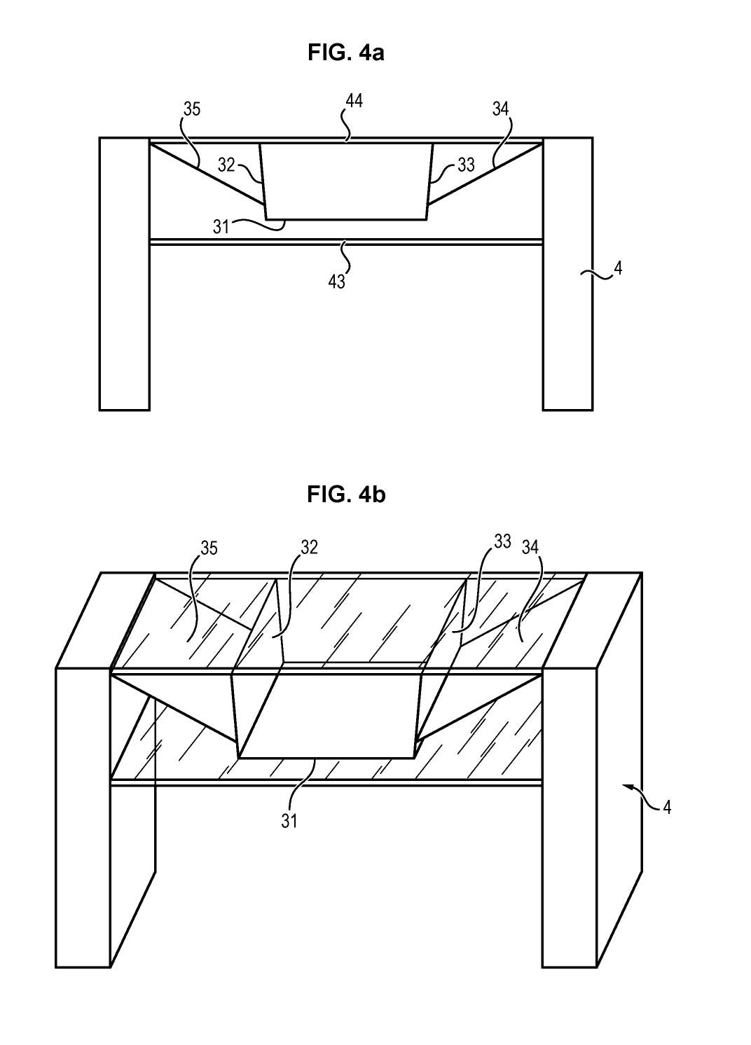

According to a second embodiment, in relation to FIGS. 4a and 4b, the reflector 3 comprises in addition to features of the first embodiment, two diagonal lateral wings 34, 35 extending from each lateral wall 32, 33 of the reflector toward the lateral walls 41, 42 of the frame 4. In this embodiment, the reflector 3 is not supported by the lower wall 43 of the frame 4 into the housing 400 but is maintained by the lateral wings 34, 35 over the lower wall 43 of the frame 4.

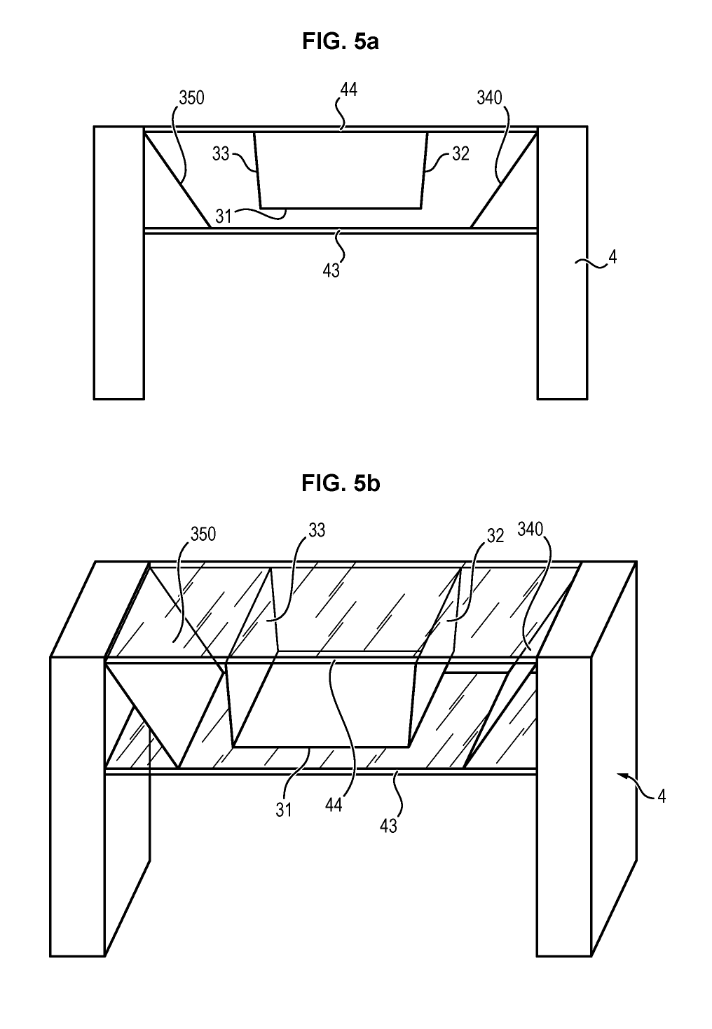

According to a third embodiment, in relation to FIGS. 5a and 5b, the reflector 3 comprises in addition to features of the first embodiment, two diagonal lateral wings 340, 350 extending from each lateral wall 41, 42 of the frame toward the bottom 43 of the frame 4. In this embodiment the reflector 3 is not supported by the lower wall 43 of the frame 4 into the housing 400 but is connected to the top wall 44 of the frame 4. Also, in this embodiment the diagonal lateral wings 340, 350 are not electrically connected with the reflector 3.

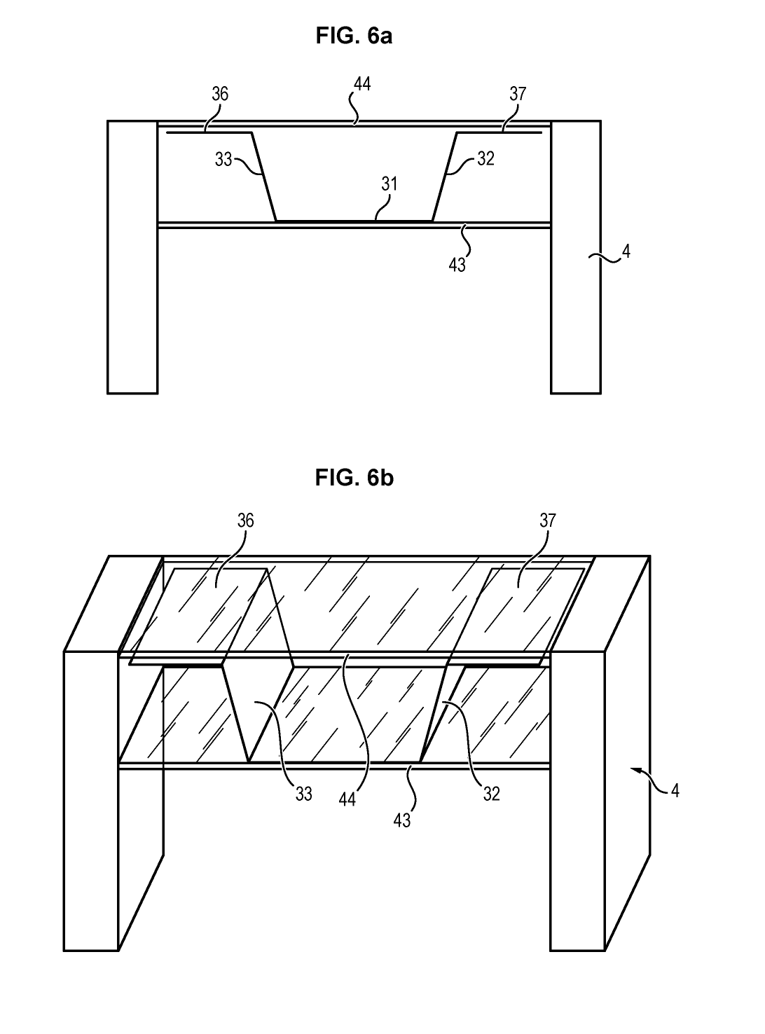

According to a fourth embodiment, in relation to FIGS. 6a and 6b, the reflector 3 comprises, in addition to features of the first embodiment, two horizontal wings 36, 37 extending horizontally from the top of the lateral walls 32, 33 of the reflector 3 towards the lateral 41, 42 walls of the frame 4, said horizontal wing being parallel to the lower wall 31 of the reflector 3. In this embodiment the reflector 3 is supported by the lower wall 43 of the frame 4.

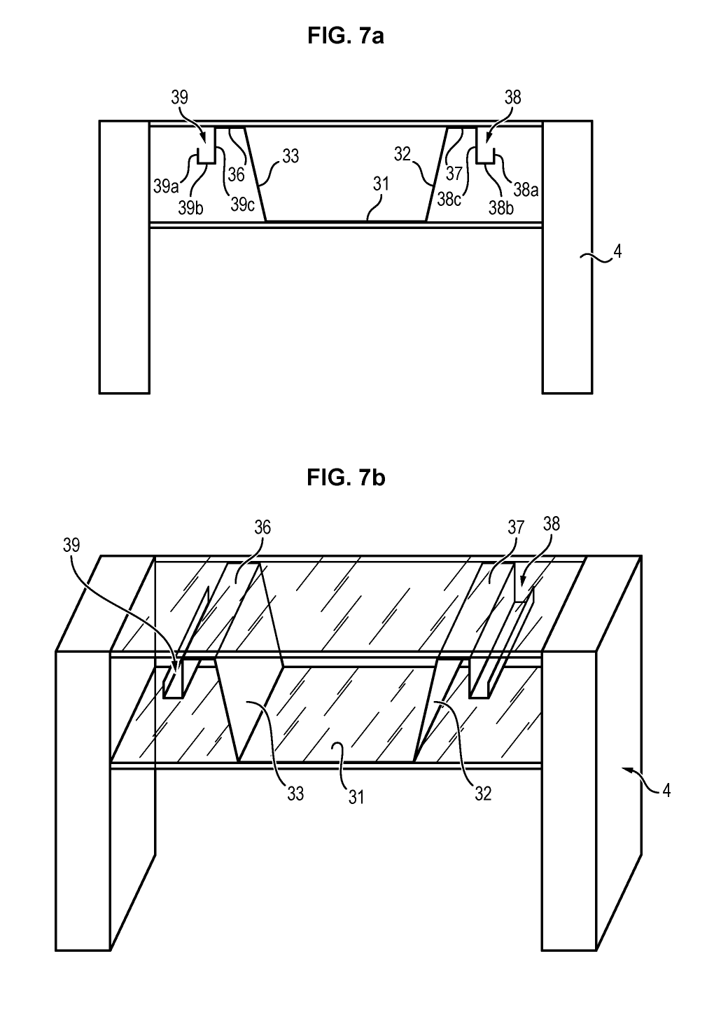

According to a fifth embodiment, in relation to FIGS. 7a and 7b, in addition to the features of the fourth embodiment, the reflector 3 comprises two electrical chokes 38, 39 which are U-shaped, and connected to each horizontal wing 36, 37. Preferably, each electrical choke comprises a first lateral wall 38c, 39c, a bottom wall 38b, 39b and two second lateral walls 38a, 39a, each lateral wall 38c, 39c, 38a, 39a being perpendicular to the horizontal wing 36, 37.

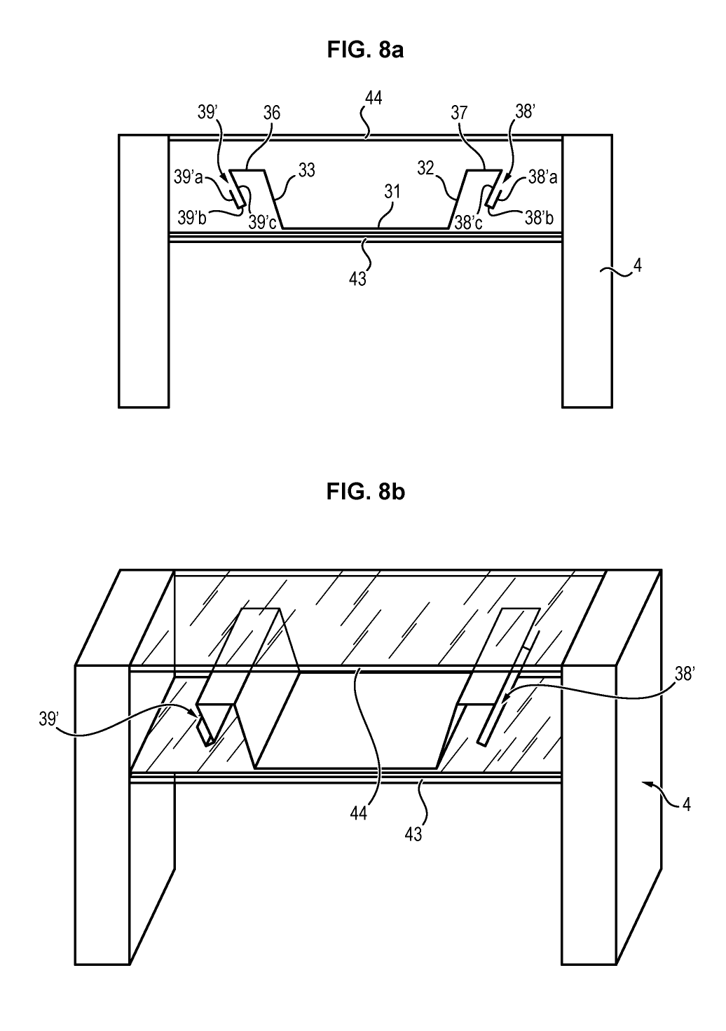

According to a sixth embodiment, in relation to FIGS. 8a and 8b, in addition to the features of the fourth embodiment, the reflector 3 comprises two electrical chokes 38′, 39′ which are U-shaped, and connected to each horizontal wing 36, 37. Preferably, each electrical choke comprises a bottom wall 38′b, 39′b, two first lateral walls 38′c, 39′c and two second lateral walls 38′a, 39′a, each lateral walls 38′c, 39′c, 38′a and 39′a being parallel to the lateral wall of the reflector 3.

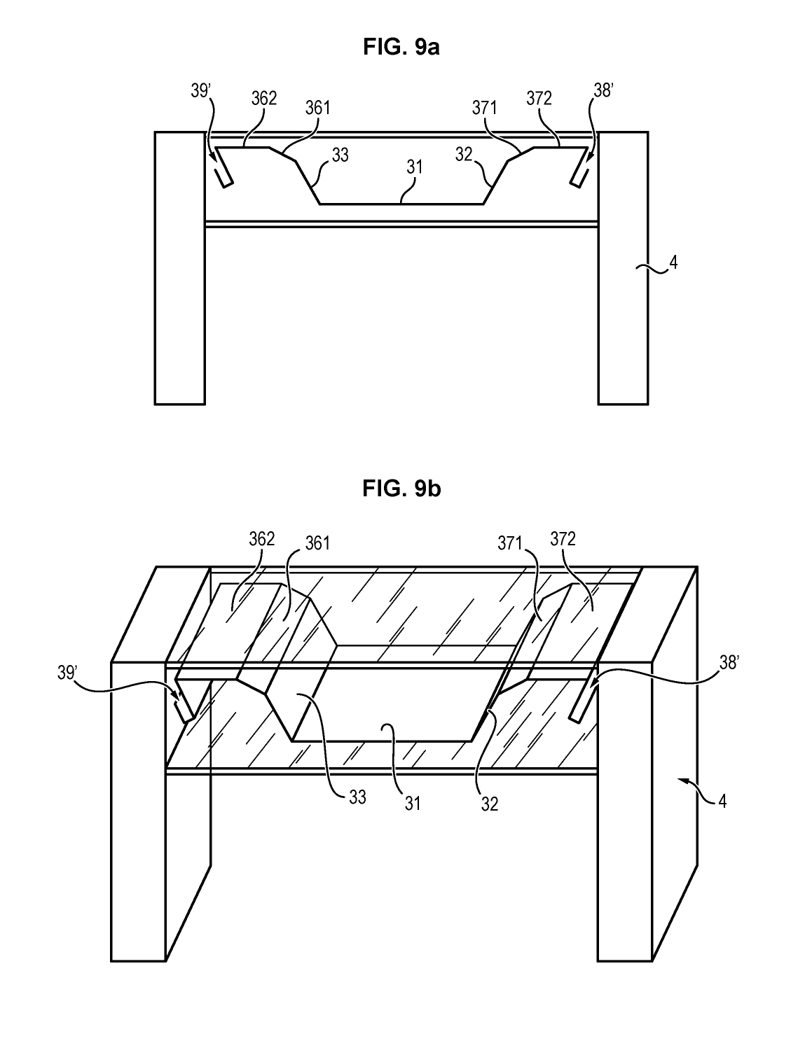

According to a seventh embodiment, in relation to FIGS. 9a and 9b, in addition to the features of the first embodiment, the reflector 3 comprises two diagonal lateral wings 361, 371 extending from the top of a lateral wall of the reflector 3, two horizontal wings 362, 372 extending horizontally from the diagonal wings 361, 371, said horizontal wing being parallel to the lower wall of the reflector 3. In this embodiment the reflector 3 also comprises two electrical chokes 38′, 39′ which are U-shaped, and connected to each horizontal wing 362, 372. Preferably, each electrical choke comprises a first lateral walls 38′a, 39′a, a bottom wall 38′b, 39′b and two second lateral walls 38′c, 39′c, each lateral wall 38′c, 39′c, 38′a, 39′a being parallel to the lateral wall of the reflector 3.

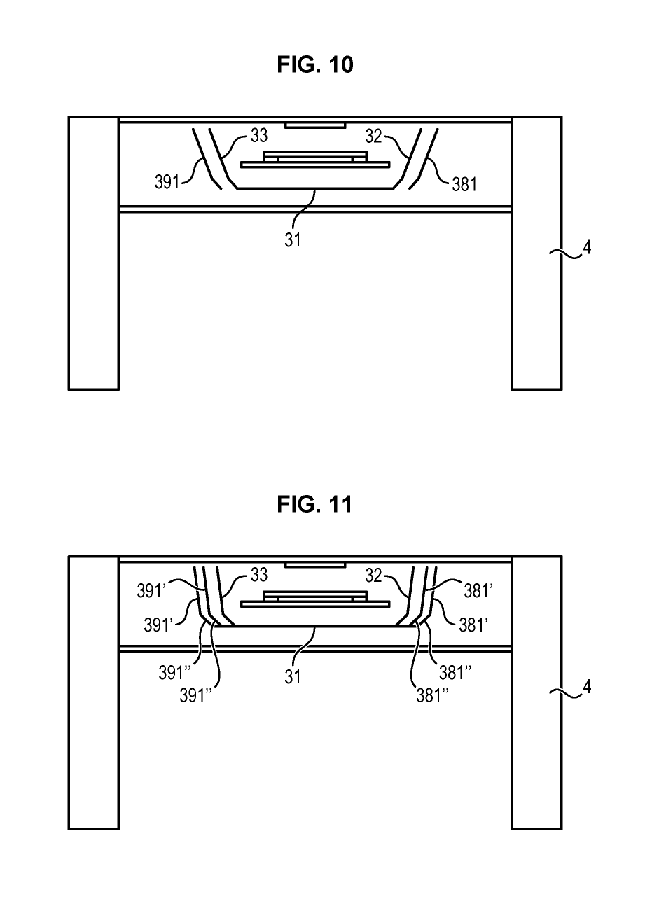

According to an eighth embodiment, in relation to FIG. 10, in addition to features of the first embodiment, the reflector 3 comprises two diagonal wings 381, 391, each being parallel to each lateral wall of the reflector for forming electrical chokes on each side of the lateral walls of the reflector 3.

According to a ninth embodiment, in relation to FIG. 11, in addition to features of the first embodiment, the reflector 3 comprises two pairs of diagonal wings 381, 381′, 381″, 391, 391′, 391″ each being parallel to each lateral wall of the reflector for forming electrical chokes on either side of the lateral walls of the reflector 3. In this embodiment, the diagonal wings are electrically connected to the reflector 3.

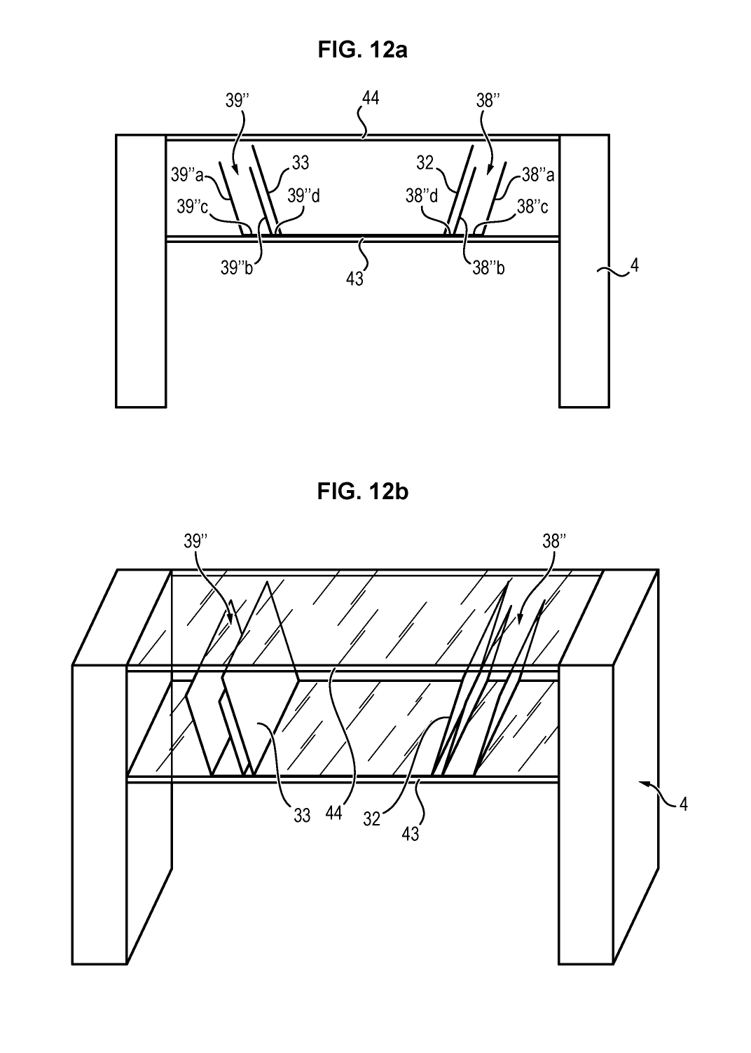

According to the tenth embodiment, in relation to FIGS. 12a and 12b, in addition to features of the first embodiment, the reflector 3 comprises two electrical chokes 38″, 39″, each comprising a bottom wall 38″c, 39″c and two lateral walls 38″a, 38″b, 39″a, 39″b each electrical chokes being disposed so that the lateral walls of the electrical chokes are parallel to the lateral walls of the reflector. Furthermore, in this embodiment the electrical chokes are electrically connected to the reflector 3 by means of an additional wall 38″d, 39″d.

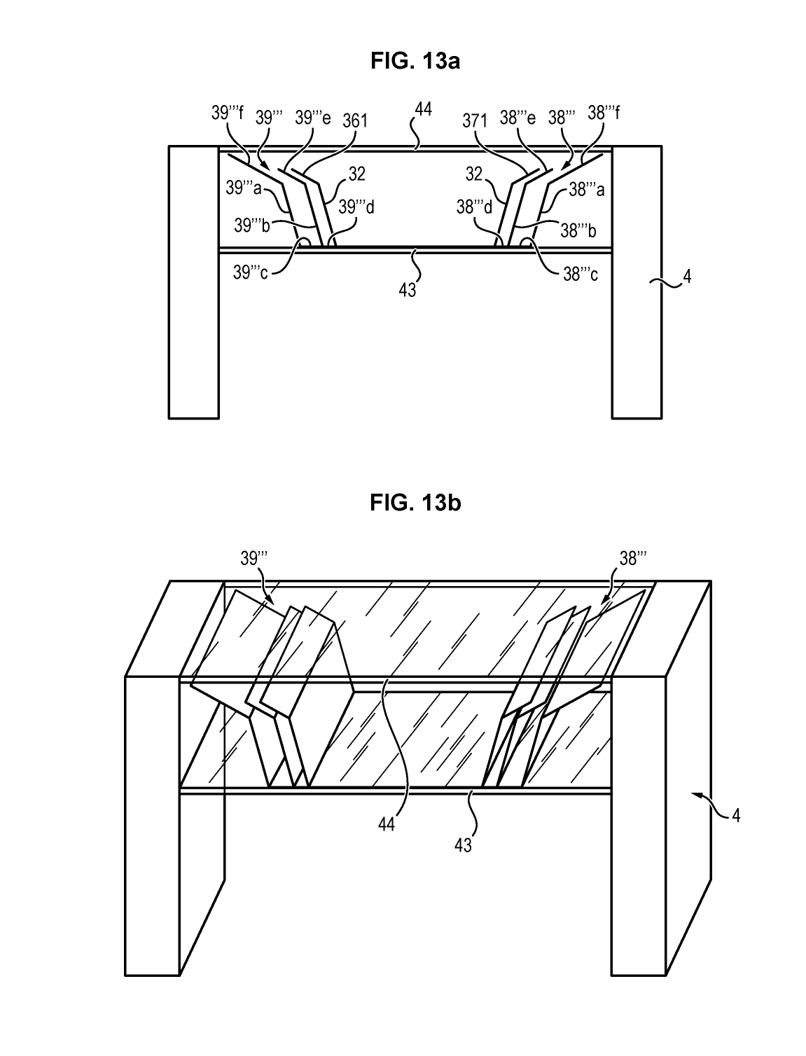

According to a eleventh embodiment, in relation to FIGS. 13a and 13b, in addition to features of the first embodiment, the reflector 3 comprises two diagonal lateral wings 361, 371 extending from the top of a lateral wall of the reflector 3 and two electrical chokes 38′″, 39′″ which are U-shaped, and connected to each diagonal lateral wings 361, 371. In this embodiment each electrical choke comprises a bottom wall 38″′c, 39″′c and two lateral walls 38″′a, 38″′b, 39″′a, 39″′b each electrical chokes being disposed so that the lateral walls of the electrical chokes are parallel to the lateral walls of the reflector 3. Additionally, each electrical choke comprises two diagonal wings 38″′e, 39″′e, 38″′f, 39″′f each extending from the top of each lateral wall of the electrical choke. Furthermore, in this embodiment the electrical chokes are electrically connected to the reflector 3 by means of an additional wall 38″′d, 38″′d.

Radiating Element

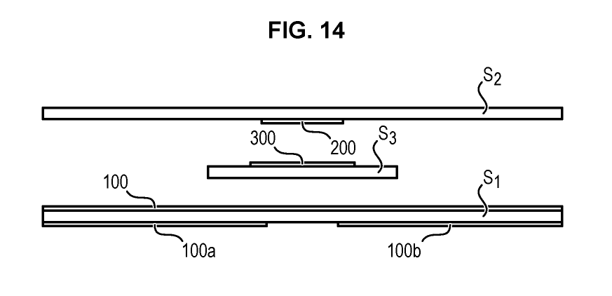

For each embodiment described above, each radiating element (see FIG. 1 and FIG. 14) comprises: a lower substrate S1; an upper substrate S2; an intermediate substrate S3; the lower substrate S1 being arranged between the lower wall 31 of the reflector 3 and the intermediate substrate S3.

Advantageously, the substrates S1, S2, S3 are optically transparent and preferably made of glass.

The radiating element further comprises a radiating assembly 100, 200, 300 arranged between the lower substrate S1 and the upper substrate S2; two transmission lines 100a, 100b formed by a conductive metallic meshing which is optically transparent said transmission lines being on the surface of the lower substrate S2 opposite the reflector 3 and which extend respectively from two opposite edges of the lower substrate S1 towards the radiating assembly such that when the transmission lines 100a, 100b are powered they cause radiation of the radiating assembly, through two slots 110a and 110b etched on a ground plane 100.

The radiating assembly comprises a ground plane 100 formed by a conductive metallic meshing, which is optically transparent, arranged on the surface of the lower substrate S1 opposite the intermediate substrate S3; a first patch 200 formed by a conductive metallic meshing arranged on the lower surface of the intermediate substrate S3 opposite the lower substrate S1, the ground plane 100 and second patch 300 being opposite each other and separated by the intermediate substrate S3. The dimensions of the first patch 200 are less than those of the ground plane 100.

Additionally, the radiating assembly also comprises an intermediate substrate S3 comprising a second patch 300 formed by a conductive metallic meshing which is optically transparent and arranged on the surface of the support substrate S3 opposite the upper substrate S2; the dimensions of the first patch 200 being less than those of the second patch 300.

The intermediate substrate S3 is suspended over the lower substrate S1 by means of non-conductive spacers S3a, S3b, S3c, S3d. This intermediate substrate S3 is preferably made of glass.

The radiating assembly further comprises two slots 110a, 110b obtained by removal of the conductive meshing of the ground plane 100

The slots are H-shaped and oriented according to an angle of 90° relative to each other and in which the transmission lines 100a, 100b extend respectively from two opposite edges of the lower substrate S1 and terminate by straddling the bar of the H of the slots 110a, 110b below.

The radiating element has been described for radiating patches but the invention also applies for other geometries of radiating patches: wired dipoles or cavity elements such as horns, or other radiating elements.

Meshing

The metallic meshing is for example of iron, nickel, chrome, titanium, tantalum, molybdenum, tin, indium, zinc, tungsten, platinum, manganese, magnesium, lead, preferably made of silver, copper, gold or aluminium or alloy of metals selected according to conductivity electrical. It typically takes the form of a grid whereof the ratio between the dimension of the openings of the mesh and the width of the metallic tracks of the mesh defines the level of optical transparency of the reflector.

It is specified here that dimensioning of the meshing is characterised by its pitch (or its periodicity), by the width and the thickness of the conductive tracks (or by the opening made in the pitch).

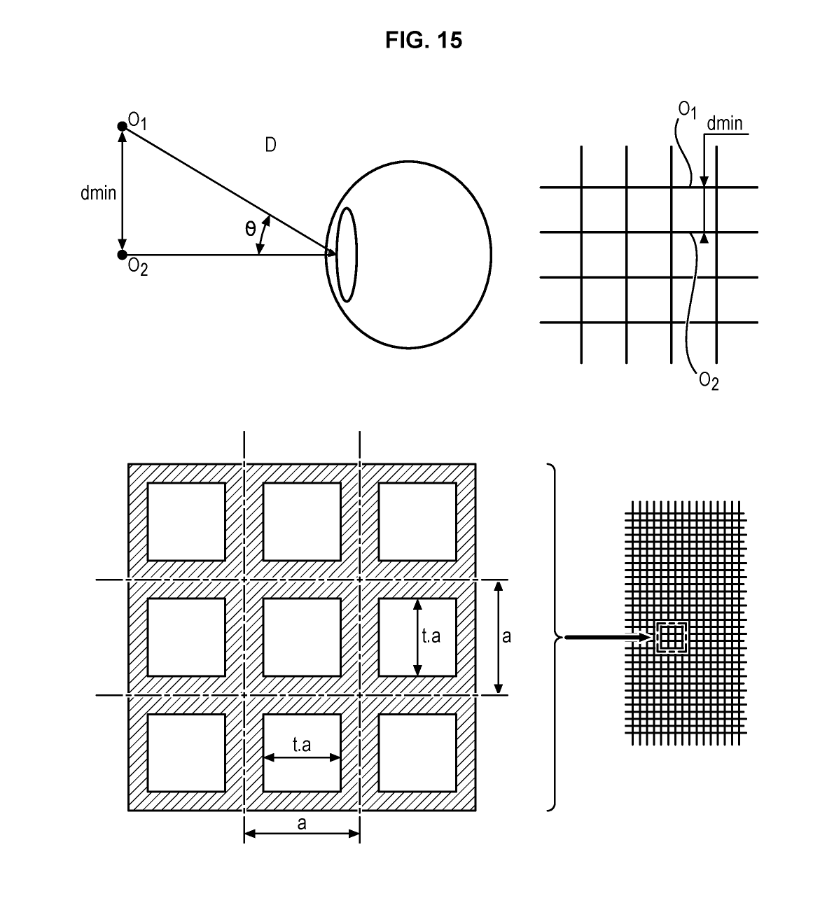

The meshing of a metallic foil is now described in relation to FIG. 15.

Metallic foil optical transmittance T is defined, in a first approximation, as the ratio of opened surfaces over total surface. This ratio can be evaluated from a single mesh of period a (i.e., the pitch), that yields: T (%)=(ta)²/a²=t² where t is a constant relating to the meshing (let us have a square of surface a×a, a hole in this square has of surface t.a×t.a). This formula permits to choose the adequate ratio t for a given transmittance T.

One the ratio t is known, the value of the mesh period a (in meter (m)) can be obtained based on electrical and optical requirements.

From the electrical point of view, the mesh period a should much lower than the operating wavelength of the optically transparent panel antenna assembly, given by the operating frequency f, in GigaHertz (GHz): a(m)<0.3/[t×K×(εr)̂(0.5)×f], where K is a safety factor, greater than 10, εr is the dielectric permittivity of the medium surrounding the metallic foil related to the air (i.e., εr(air)=1). However, if the metallic foil lays on a substrate, it must be considered εr as high as the substrate permittivity, although the real value is lower.

From the optical point of view, optical transparency and optical discretion are needed. The latter is defined as a function of human eye acuity, which is the eye ability to distinguish objects separated from a distance d, from an observation distance D. As illustrated on FIG. 15, the human eye can distinguish two objects O1, O2 if an angle θm between the two objects O1, O2 is greater than 4.8×10⁻⁴ rad. In an ideal case, the mesh must not be visible from a shorter observation distance which is known as the “punctum proximum”, with a mean value of 24 centimeters that yields: dmin=D×tan (θm)=25.10⁻²×tan(θm)=120 μm. This ideal case yields to a very high mesh resolution corresponding to metallic tracks of width close to 30 micrometers for an optical transmittance of 80%. This case is possible for surfaces of the mesh not greater than 400 mm×400 mm.

For minimum observation distance of 1 meter, dmin=1×tan(θm)=480 μm.

One can note that satisfaction of optical requirements leads to the satisfaction of electrical requirements.

The metallic meshing can be made physically (PVD), for example by pulverisation, vacuum evaporation, laser ablation, etc. or again by other methods, for example chemical deposit (silvering, coppering, gilding, aluminiuming, tinning, nickeling . . . ), by silkscreen printing, by electrolytic deposit, by chemical deposit in vapour phase (CVD, PECVD, OMCVD . . . ), etc.

The openings of the metallic meshing in the metallic foil can be made by standard photolithography from a photomask or a mask transferred by laser writer onto a reserve and associated chemical etching, or by tampography followed by chemical etching, or again by ionic etching through a mask.

The meshing can also be done directly by screen printing, by conductive inkjet printing (and associated annealing), by electroforming, by direct writing via decomposition by laser beam of an organometallic, etc. It can be also made of transparent semiconductor materials such as Indium Thin Oxide (ITO).

1. Optically transparent panel antenna assembly comprising an optically transparent antenna (1) having an array of radiating elements (21, 22, 23) that transmit or receive RF signals, said assembly comprising a reflector (3) optically transparent, said reflector (3) comprising a lower wall (31), two lateral walls (32, 33) each lateral wall extending therefrom the lower wall (31) so that the array of radiating elements (21, 22, 23) is maintained between both lateral walls (32, 33) of the reflector (3).

2. Optically transparent panel antenna assembly according to claim 1, comprising a frame (4) having two lateral walls (41, 42), a bottom and a top walls (43, 44), the lateral walls and the top and the bottom walls defining a housing (400) for the optically transparent antenna (1).

3. Optically transparent panel antenna assembly according to claim 1, wherein the reflector (3) comprises two diagonal lateral wings (34, 35) extending from each lateral wall (32, 33) of the reflector toward the lateral walls (41, 42) of the frame (4).

4. Optically transparent panel antenna assembly according to claim 1, the reflector (3) comprises two diagonal lateral wings (340, 350) extending from each lateral wall (41, 42) of the frame toward the bottom (43) of the frame (4).

5. Optically transparent panel antenna assembly according to claim 1, wherein the reflector (3) comprises two horizontal wings (36, 37) extending horizontally from the top of the lateral walls (32, 33) of the reflector towards the lateral (41, 42) walls of the frame, said horizontal wing being parallel to the lower wall (31) of the reflector (3).

6. Optically transparent panel antenna assembly according to claim 1, wherein the reflector (3) comprises two diagonal wings (361, 371) extending from the top of a lateral wall of the reflector (3), two horizontal wings (362, 372) extending horizontally from the diagonal wings (361, 371), said horizontal wing being parallel to the lower wall of the reflector (3).

7. Optically transparent panel antenna assembly according to claim 5, wherein the reflector (3) comprises two electrical chokes (38, 38′, 39, 39′) which are U-shaped, and connected to each horizontal wing (36, 37).

8. Optically transparent panel antenna assembly according to claim 7, wherein the electrical choke comprises a bottom wall and two lateral walls, each lateral wall being parallel to the bottom wall of the reflector or parallel to the lateral wall of the reflector.

9. Optically transparent panel antenna assembly according to claim 1, wherein the reflector (3) comprises at least one diagonal wing (381, 381′, 391, 391′) parallel to each lateral wall of the reflector for forming electrical chokes on either side of the lateral walls of the reflector (3).

10. Optically transparent antenna assembly according to claim 1, wherein the reflector comprises two electrical chokes each comprising a bottom wall and two lateral walls, each electrical chokes being disposed so that the lateral walls of the electrical chokes are parallel to the lateral walls of the reflector.

11. Optically transparent panel antenna assembly according to claim 1, wherein each radiating element comprises a lower substrate (S1); an upper substrate (S2); and an intermediate substrate (S3); being arranged between the lower wall of the reflector (3) and the upper wall (44), the substrates being optically transparent and preferably made of glass.

12. Optically transparent panel antenna assembly according to claim 11, comprising a radiating assembly arranged between the lower substrate (S1) and the upper substrate (S2); two transmission lines formed by metallic meshing on the surface of the lower substrate (S1) opposite the lower wall of the reflector (3) and which extend respectively from two opposite edges of the lower substrate (S1) towards the radiating assembly such that when the transmission lines are powered they cause radiation of the radiating assembly, through two slots (110a, 110b) etched on the ground plane (100).

13. Optically transparent panel antenna assembly according to claim 1, wherein the reflector is constituted by a substrate which is optically transparent and a layer of a metallic meshing.

14. Optically transparent panel antenna assembly according to claim 13, wherein the metallic meshing is a metallic squared mesh in form of a grid.

15. Optically transparent panel antenna assembly according to claim 14, wherein the metallic meshing is made of transparent semiconductor materials such as Indium Thin Oxide (ITO).
